(19) United States
(12) Patent Application Publication
(10) Pub. No.: US 2025/0210748 A1
(43) Pub. Date: Jun. 26, 2025

(54) Electrode Assembly and Secondary Battery Including the Same

(71) Applicant: LG Energy Solution, Ltd., Seoul (KR)

(72) Inventors: Seung Hyun Lee, Daejeon (KR); Su Hwan Kim, Daejeon (KR); Ji Su Hong, Daejeon (KR); Kyung Hwan Jung, Daejeon (KR)

(73) Assignee: LG Energy Solution, Ltd., Seoul (KR)

(21) Appl. No.: 18/981,851

(22) Filed: Dec. 16, 2024

(30) Foreign Application Priority Data
Dec. 20, 2023 (KR) 10-2023-0187656
Oct. 2, 2024 (KR) 10-2024-0133868

(51) Int. Cl. H01M 10/647; H01M 10/0585; H01M 10/658; H01M 50/105; H01M 50/533

(52) U.S. Cl. CPC H01M 10/647; H01M 10/0585; H01M 10/658; H01M 50/533; H01M 50/105

(57) ABSTRACT

An electrode assembly includes: an electrode stack in which an electrode and a separator are alternately interposed; and an electrode lead extending from the electrode. A thickness of the electrode stack is 15 times or more a thickness of the electrode lead so as to prevent or suppress heat propagation to an adjacent secondary battery.

### CROSS-REFERENCE TO RELATED APPLICATIONS

This application is based on and claims priority from Korean Patent Application No. 10-2023-0187656 filed on Dec. 20, 2023 and Korean Patent Application No. 10-2024-0133868 filed on Oct. 2, 2024 with the Korean Intellectual Property Office, the disclosure of which is incorporated herein in its entirety by reference.

### TECHNICAL FIELD

The present disclosure relates to an electrode assembly and a secondary battery.

### BACKGROUND

As the technology development and the demand for electric vehicles, mobile devices, and the like, increase, the demand for secondary batteries as an energy source is increasing. Unlike primary batteries, secondary batteries can be reused through charging even after being used up. A secondary battery includes a positive electrode and a negative electrode. When metal is oxidized at the positive electrode, electricity is generated by the movement of electrons released from the metal.

### SUMMARY

According to an embodiment of the present disclosure, provided is an electrode assembly in which the occurrence of thermal runaway is prevented or suppressed.

In the embodiment of the present disclosure, provided is a secondary battery in which the occurrence of thermal runaway in an adjacent secondary battery is prevented or suppressed.

An electrode assembly, according to one embodiment of the present disclosure, includes an electrode stack in which an electrode and a separator are alternately interposed; and an electrode lead extending from the electrode. The thickness of the electrode stack is about 15 times or more the thickness of the electrode lead, so as to prevent or suppress the heat propagation to an adjacent secondary battery.

The electrode lead may be a positive electrode lead.

The electrode lead may be a positive electrode lead, and the thickness of the electrode stack may be about 22 times or more the thickness of the positive electrode lead.

The electrode lead may be a positive electrode lead, and the thickness of the electrode stack may be about 70 times or more the thickness of the positive electrode lead.

The electrode lead may be a negative electrode lead, and the thickness of the electrode stack may be about 30 times or more the thickness of the negative electrode lead.

The electrode lead may be a negative electrode lead, and the thickness of the electrode stack may be about 45 times or more the thickness of the negative electrode lead.

The electrode lead may be a negative electrode lead, and the thickness of the electrode stack may be about 140 times or more the thickness of the negative electrode lead.

The thickness of the electrode stack may be about 14 mm or more.

The thickness of the electrode stack may be about 20 mm or more.

The thickness of the electrode stack may be about 28 mm or more.

The electrode assembly further includes a battery casing configured to accommodate the electrode stack. The battery casing may include a receiving portion having a shape corresponding to the electrode stack, and a depth of the receiving portion may be about 7.5 times or more the thickness of the electrode lead.

The receiving portions may be provided as a pair and located on opposite sides of the electrode stack, and a sum of depths of the pair of receiving portions may be about 28 mm or more.

The thickness may be about 0.28 times or more a full length.

The thickness of the electrode assembly may be about 0.09 times or more a full width.

A plurality of electrode stacks may be provided, and the electrode stacks may be arranged in a thickness direction.

A secondary battery according to one embodiment of the present disclosure includes: an electrode stack in which a plurality of electrodes and a plurality of separators are provided, each of the plurality of separators being alternately stacked with the plurality of electrodes; and a battery casing that accommodates the electrode stack. The electrode stack includes 134 or less electrodes to prevent or suppress heat propagation to an adjacent secondary battery.

The electrode stack may include 67 or more electrodes.

The electrode stack may have a thickness of about 28 mm or less.

The thickness of the electrode stack may be about 14 mm or more.

A secondary battery according to one embodiment of the present disclosure includes: an electrode stack; and a battery casing that includes a receiving portion where a recessed space for accommodating the electrode stack is formed, and a side portion extending from the receiving portion. The receiving portion is formed through stretching by a press, and is configured to have a depth of about 14 mm or less, which is a maximum stretching degree.

The secondary battery according to the present disclosure may prevent or suppress the occurrence of thermal runaway because the electrode stack has a thickness equal to or greater than a predetermined thickness.

In the secondary battery according to the present disclosure, since the electrode stack has a thickness equal to or greater than a predetermined thickness, the heat transferred to an adjacent secondary battery is reduced. Thus, it is possible to prevent or suppress the occurrence of thermal runaway in the adjacent secondary battery.

The effects that may be obtained in the present disclosure are not limited to the effects mentioned above, and other effects which are not mentioned will be clearly understood from the following descriptions by a person with ordinary skill in the technical field to which the present disclosure pertains.

### BRIEF DESCRIPTION OF THE DRAWINGS

The following drawings attached hereto illustrate embodiments of the present disclosure and serve to help further understand the technical idea of the present disclosure together with the detailed description of the disclosure to be described later. Therefore, the present disclosure should not be construed as being limited to the matters illustrated in the drawings.

FIG. 1 is an assembly view illustrating a secondary battery, according to a first embodiment of the present disclosure.

FIG. 2 is a perspective view illustrating a finished product obtained through the assembling of the secondary battery illustrated in FIG. 1.

FIG. 3 is a cross-sectional view illustrating a portion of the secondary battery obtained by cutting the secondary battery illustrated in FIG. 2.

FIG. 4A is a photograph taken for a case where the depth of a receiving portion is about 14 mm, and FIG. 4B is a photograph taken for a case where the depth of the receiving portion exceeds about 14 mm.

FIG. 5 is a graph illustrating thermal energy over time when a heat source is placed on one side of a secondary battery according to Comparative Example.

FIG. 6 is a graph illustrating thermal energy when a heat source is placed on one side of the secondary battery according to the first embodiment of the present disclosure.

FIG. 7 is a graph summarizing the results of an experiment conducted to determine the effect of the secondary battery according to the first embodiment of the present disclosure.

FIG. 8 is a graph illustrating the time for a voltage drop measured by varying the thickness of the secondary battery in relation to the experiment illustrated in FIG. 6 or FIG. 7.

FIG. 9 is an exploded view illustrating a battery module including the secondary battery illustrated in FIG. 2.

FIG. 10 is a cross-sectional view illustrating a secondary battery according to a second embodiment of the present disclosure.

FIG. 11 is a cross-sectional view illustrating a secondary battery according to a third embodiment of the present disclosure.

FIG. 12 is a cross-sectional view illustrating a secondary battery according to a fourth embodiment of the present disclosure.

FIG. 13 is a cross-sectional view illustrating a secondary battery according to a fifth embodiment of the present disclosure.

### DETAILED DESCRIPTION

Hereinafter, embodiments of the present disclosure will be described with reference to accompanying drawings so that a person with ordinary skill in the technical field to which the present disclosure belongs can easily implement the present disclosure. However, the present disclosure may be implemented in various different modes, and is not limited or restricted by the following embodiments.

In order to clearly describe the present disclosure, detailed descriptions of portions unrelated to the present disclosure or known technologies that may unnecessarily obscure the gist of the present disclosure have been omitted. Additionally, when assigning reference numerals to components in each drawing in this specification, the same or similar reference numerals are assigned to the same or similar components throughout the specification.

In addition, the terms or words used in the specification and claims should not be construed as being limited to their ordinary or dictionary meanings, but should be construed as meanings and concepts consistent with the technical idea of the present disclosure based on the principle that an inventor may appropriately define the concepts of terms in order to explain their invention in the best way.

It should be understood that various embodiments of the present document and the terms used therein are not intended to limit the technical features described in the present document, to specific embodiments, but rather to encompass various modifications, equivalents, or substitutes of the corresponding embodiment.

Regarding the description of drawings, similar reference numerals may be used for similar or relevant components.

A singular form of a noun corresponding to an item may include one or more corresponding items unless the relevant context explicitly indicates otherwise.

In this document, each of phrases such as “A or B”, “at least one of A and B”, “at least one of A or B”, “A, B or C”, “at least one of A, B and C”, and “at least one of A, B, or C” may include any one of items listed together in the corresponding phrase among the phrases, or all possible combinations thereof.

The term [0001] “and/or” includes a combination of related mentioned components or any of the related mentioned components.

Terms such as “first”, “second”, or “primary” or “secondary” may be simply used to distinguish a corresponding component from another corresponding component, and do not limit the corresponding components in other aspects (e.g., importance or order).

When a certain (e.g., first) component is referred to as being “coupled” or “connected” to another (e.g., second) component with or without a term “functionally” or “communicatively”, this means that the certain component can be connected to another component directly (e.g., wired), wirelessly, or via a third component.

The terms such as “include” or “have” are intended to specify the presence of features, numbers, steps, operations, components, parts described in this document or combinations thereof, but do not preclude possibilities of presence or addition of one or more other features, numbers, steps, operations, components, parts or combinations thereof, in advance.

When a certain component is said to be “connected to”, “coupled to”, “supported by” or “in contact with” another component, this includes not only a case where components are directly connected, coupled, supported or in contact with each other, but also a case where components are indirectly connected, coupled, supported or in contact with each other via a third component.

When a certain component is said to be located “on” another component, this includes not only a case where a certain component is in contact with another component, but also a case where another component is present between two components.

Meanwhile, the terms such as “up and down direction”, “downward”, and “front and rear direction” used in the following description are defined on the basis of drawings, and the shape and position of each component are not limited by these terms.

“About”, “approximately”, and “substantially” used in the present specification are used to mean ranges of numerical values or degrees or approximations thereof, taking into account inherent manufacturing and material tolerances.

In order to manufacture a secondary battery, electrode active material slurries are first applied to a positive electrode current collector and a negative electrode current collector to manufacture a positive electrode and a negative electrode, and then an electrode assembly is formed by stacking the positive electrode and the negative electrode on both sides of a separator. Then, the electrode assembly is accommodated in a battery casing, and an electrolyte is injected, and then sealing is performed.

In the secondary battery, a thermal runaway phenomenon may occur due to, for example, a side reaction. When a thermal runaway phenomenon occurs in the secondary battery, the corresponding secondary battery breaks down, and may not perform its intended function thereafter.

A plurality of secondary batteries may be arranged to be provided as a battery module, or a plurality of battery modules or secondary batteries may be arranged to be provided as a battery pack. In this case, when a thermal runaway phenomenon occurs in one secondary battery, the thermal runaway may be transferred to an adjacent secondary battery may to generate a flame, and accordingly, the flame may be transferred to a device equipped with, for example, the battery pack. This may cause a problem in which the safety of a user using the device is threatened. In consideration of the fact that such a problem exists, the present disclosure provides, for example, an electrode assembly in which an occurrence of the thermal runaway is prevented or suppressed.

### First Embodiment

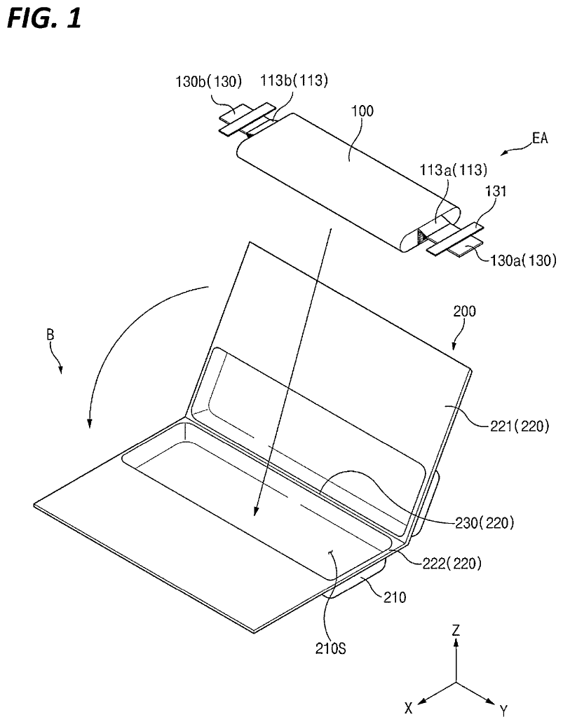

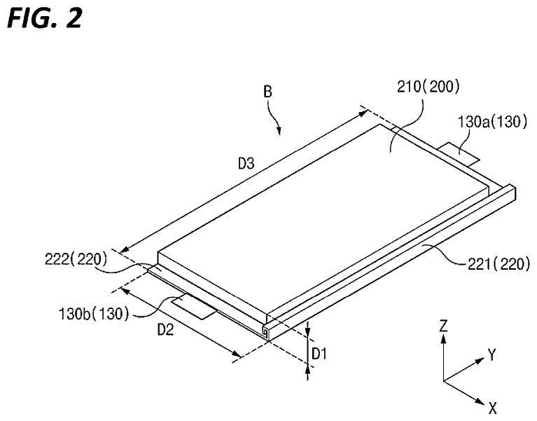

FIG. 1 is an assembly view illustrating a secondary battery B, according to a first embodiment of the present disclosure. FIG. 2 is a perspective view illustrating the finished product obtained through the assembling of the secondary battery B illustrated in FIG. 1.

As illustrated in FIGS. 1 and 2, the secondary battery B configured to generate electricity may be provided.

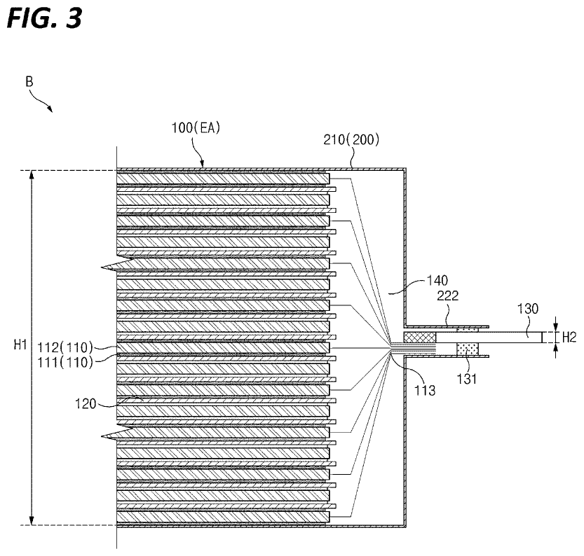

The secondary battery B according to the embodiment may include an electrode assembly EA. The electrode assembly EA may be formed by alternately stacking electrodes 110 and separators 120. First, slurries obtained by mixing active materials for the electrodes 110, a binder, and a plasticizer may be applied to a positive electrode current collector 112 and a negative electrode current collector 112 to manufacture the electrodes 110 such as a positive electrode and a negative electrode. Then, the separators 120 are stacked between the electrodes 110 to form the electrode assembly EA, and the electrode assembly EA may be inserted into a battery casing 200. After an electrolyte 140 is injected, sealing may be performed (see, e.g., FIG. 3). According to one embodiment, the battery casing 200 may be a pouch or a pouch type, and the battery casing 200 may be formed from a pouch film.

The electrode assembly EA may include two types of electrodes 110 (e.g., a positive electrode and a negative electrode) and the separator 120 that is interposed between the electrodes 110 in order to insulate the electrodes 110 from each other. The electrode assembly EA may be provided as a stack type, a jelly roll type, a stack and folding type, and the like, according to the way in which the positive electrode, the negative electrode, and the separator 120 are stacked. In the structures of two types of electrodes 110 (e.g., the positive electrode and the negative electrode), active material slurries may be applied to metal foil or metal mesh-type current collectors 112 for the electrodes 110, which include aluminum and copper, respectively. In general, the slurry may be formed by stirring, for example, a granular active material, an auxiliary conductor, a binder, and a plasticizer, in a state where a solvent is added. The solvent of the slurry may be removed in a subsequent process.

Electrode tabs 113 are connected to the positive electrode and the negative electrode of the electrode assembly EA, respectively, may protrude to the outside of the electrode assembly EA, and may become paths through which electrons are movable between the inside and outside of the electrode assembly EA. As illustrated in FIG. 1, the electrode tabs 113 may protrude in different directions of the electrode assembly EA, but the present disclosure is not limited thereto. The electrode tabs 113 may protrude in parallel in the same direction or may protrude in various directions.

The electrode assembly EA may include an electrode lead 130 that is connected to the electrode tab 113 to supply electricity to the outside of the secondary battery B. The electrode lead 130 may be connected to the electrode tab 113 by spot welding, etc.

The electrode assembly EA may include an insulating portion 131 surrounding a portion of the electrode lead 130. The insulating portion 131 may be located to correspond to a position where side portions 220 of the battery casing 200 to be described below are fused. When the facing side portions 220 are fused to each other, the insulating portion 131 may be positioned between the side portions 220 so that the electrode lead 130 may be attached to the pouch. Then, electricity generated from the electrode assembly EA may be prevented or suppressed from flowing to the pouch through the electrode lead 130, and sealing of the pouch may be maintained. Therefore, the insulating portion 131 may be made of a non-conductor that has non-conductivity and does not conduct electricity well. For example, the insulating portion 131 may be an insulating tape that is easily attached to the electrode lead 130 and has a relatively small thickness. However, the present disclosure is not limited thereto, and various members may be used, as long as the electrode lead 130 is insulated.

The electrode tab 113 configured to have the positive electrode may be referred to as a positive electrode tab 113a, the electrode tab 113 configured to have the negative electrode may be referred to as a negative electrode tab 113b, the electrode lead 130 configured to have the positive electrode may be referred to as a positive electrode lead 130a, and the electrode lead 130 configured to have the negative electrode may be referred to as a negative electrode lead 130b. One end of the electrode lead 130 may be connected to the electrode tabs 113, and the other end may protrude to the outside of the pouch. The electrode lead 130 may include the positive electrode lead 130a having one end connected to the positive electrode tabs 113a and extending in the protruding direction of the positive electrode tabs 113a, and the negative electrode lead 130b having one end connected to the negative electrode tabs 113b and extending in the protruding direction of the negative electrode tabs 113b. Meanwhile, the other ends of both the positive electrode lead 130a and the negative electrode lead 130b may protrude to the outside of the pouch. Accordingly, the positive electrode lead 130a and the negative electrode lead 130b may supply electricity generated inside the electrode assembly EA, to the outside. Also, the positive electrode tab 113a and the negative electrode tab 113b may extend in various directions, respectively.

The material of the positive electrode lead 130a may be different from the material of the negative electrode lead 130b. The positive electrode lead 130a may be made of the same aluminum material as the positive electrode current collector 112, and the negative electrode lead 130b may be made of the same copper material as the negative electrode current collector 112 or a nickel-coated copper material. A portion of the electrode lead 130 protruding to the outside of the pouch may serve as a terminal portion and may be electrically connected to an external terminal.

The pouch may be made of a material having high flexibility in order to accommodate the electrode assembly EA therein. When a flexible pouch film is subjected to drawing-molding by using, for example, a punch (not illustrated), a part of the pouch film is stretched and a receiving portion 210 having a pocket-shaped electrode receiving space 210S is formed so that the pouch may be manufactured. The pouch may accommodate the electrode assembly EA such that a portion of the electrode lead 130 is exposed, and the pouch may be sealed.

The pouch film may include a plurality of layers. The pouch film may include a sealant layer and a barrier layer located outside the sealant layer. According to one embodiment, the pouch film may include a surface protection layer located outside the barrier layer. Here, the sealant layer may include a polymer material such as polypropylene, the barrier layer may include a metal material such as aluminum, and the surface protection layer may include a polymer material such as nylon.

When the pouch film is molded into the receiving portion 210, only one receiving portion 210 may be formed in one pouch film, but the present disclosure is not limited thereto. One pouch film may also be subjected to drawing-molding such that two receiving portions 210 may be adjacent to each other. Then, two adjacent receiving portions 210 may be formed. The respective depths of the receiving portions 210 may be the same, but are not limited thereto. The respective depths of the receiving portions 210 may be different from each other. After the electrode assembly EA is accommodated in one receiving portion 210, the pouch may be folded around an axis such that another receiving portion 210 faces the receiving portion 210 where the electrode assembly EA is accommodated. Accordingly, another receiving portion 210 may accommodate the electrode assembly EA from the upper side. Since two receiving portions 210 accommodate one electrode assembly EA, the electrode assembly EA with a larger thickness may be accommodated compared to when there is one receiving portion 210. Also, as the pouch is folded, the individual side portions 220 are integrally connected to form a folding portion 230. Thus, when a sealing process is performed later, the number of sides to be sealed may be reduced. Therefore, it is possible to improve the process speed, and also to reduce the number of sealing processes.

The side portions 220 may include a lead sealing portion 222 configured to be positioned corresponding to the electrode lead 130, and a degas sealing portion 221 connected to the lead sealing portion 222. First, the lead sealing portion 222 may be sealed by fusing. Thereafter, the electrolyte 140 may be injected into the electrode receiving space 210S through the degas sealing portion 221 that is not yet sealed, and the degas sealing portion 221 may be sealed by fusing. Thereafter, an activation process is performed. Then, when the gas generated through the activation process moves to the inside of the degas sealing portion 221, the remaining gas is removed by forming a hole. The degas sealing portion 221, which is located closer to the receiving portion 210 than the portion where the hole is formed, is sealed again, and then, a trimming process may be performed to cut off unnecessary portions so that the degas sealing portion 221 may have a predetermined width. Thereafter, the degas sealing portion 221 may be folded to reduce the width.

FIG. 3 is a cross-sectional view illustrating a portion obtained by cutting the secondary battery B illustrated in FIG. 2.

Referring to FIG. 3, the secondary battery B may include an electrode stack 100 in which the electrodes 110 and the separators 120 are alternately interposed. The electrodes 110 and the separators 120 may be stacked in the up and down direction on the basis of FIG. 3. As mentioned above, the electrode 110 may include the current collector 112, and an active material layer 111 applied on the current collector 112. The secondary battery B may include the electrode lead 130 extending from the electrodes 110. The electrode lead 130 may include a material with excellent conductivity to transmit electricity generated by the electrodes 110 to the outside of the secondary battery B.

The electrode stack 100 may be thickly provided. A situation in which a thermal runaway occurs in the secondary battery B may occur when an unintentional side reaction occurs inside the secondary battery B. Meanwhile, as the heat exceeding a predetermined value is introduced, a thermal runaway may occur in the secondary battery B due to the heat. When the thermal runaway occurs, side reactions occur while generating heat in the secondary battery B, and when the degree of thermal runaway is severe, ignition may occur.

When the electrode stack 100 is thinly formed, a small amount of heat may be required for the thermal runaway to occur in the secondary battery B. When the electrode stack 100 is thickly formed, a larger amount of heat is required for the thermal runaway to occur in the secondary battery B. Therefore, the thermal runaway of the secondary battery B may be prevented or suppressed to some extent by forming the electrode stack 100 thickly.

In order to prevent or suppress the thermal runaway of the secondary battery B or to prevent or suppress the diffusion of the thermal runaway into the adjacent secondary battery B even when the thermal runaway occurs in the secondary battery B, there have been attempts to add a separate member at the level of a battery module (BM). When such a configuration for preventing or suppressing the thermal runaway at the level of the secondary battery B is adopted, a separate member does not need to be used to prevent or suppress the thermal runaway, and thus, a production cost for adding the separate member and a material cost consumed for adding the separate member, may be saved.

The thickness of the conventional secondary battery B was approximately 9 mm.

The thickness H1 of the electrode stack 100, according to the first embodiment of the present disclosure, may be about 14 mm or more. Alternatively, the thickness H1 of the electrode stack 100 may be about 20 mm or more. Alternatively, the thickness H1 of the electrode stack 100 may be about 28 mm. However, the thickness of the electrode stack 100 may be limited by the depth of the receiving portion 210 included in the battery casing 200. The receiving portion 210 may be formed by pressing the pouch that is a raw material of the battery casing 200. Here, when the pouch is pressed, the pouch may become thinner, thereby forming the receiving portion 210. That is, the pouch may be stretched, thereby forming the receiving portion 210. Here, the pouch may not be infinitely stretched, but may be stretched with a predetermined limit of elongation.

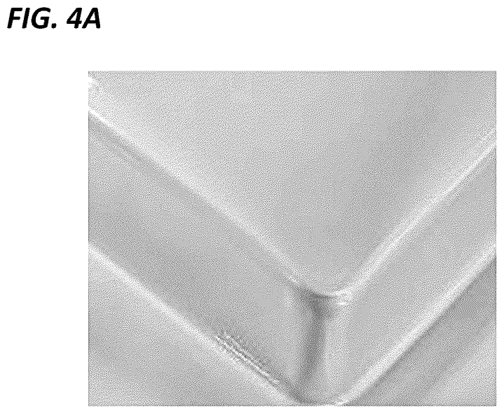

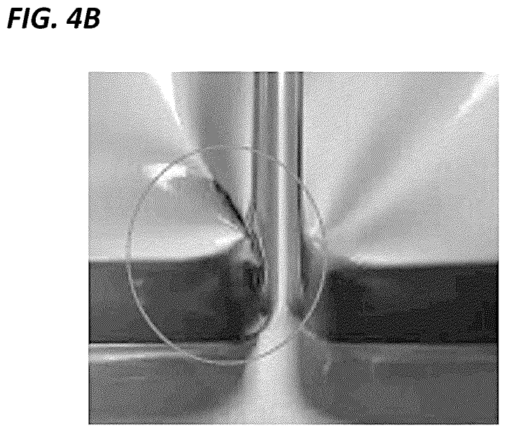

FIG. 4A is a photograph taken for a case where the depth of the receiving portion 210 is about 14 mm. FIG. 4B is a photograph taken for a case where the depth of the receiving portion 210 exceeds about 14 mm.

The predetermined limit of elongation may be set corresponding to the depth of the receiving portion per pouch, 14 mm. As in the photograph illustrated in FIG. 4A, when the depth of the receiving portion 210 is about 14 mm, it can be found that no crack occurred in the pouch. However, as in the photograph illustrated in FIG. 4B, when the depth of the receiving portion 210 exceeds about 14 mm, a crack may occur in the pouch.

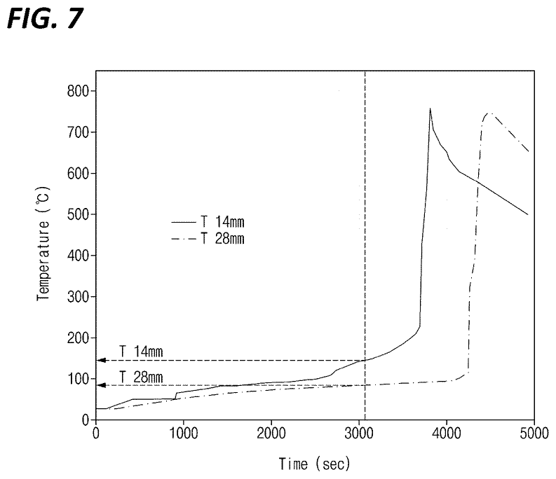

Since experimental data related to the thickness and temperature are illustrated in FIG. 7, experimental data will be examined in the explanation section related to FIG. 7.

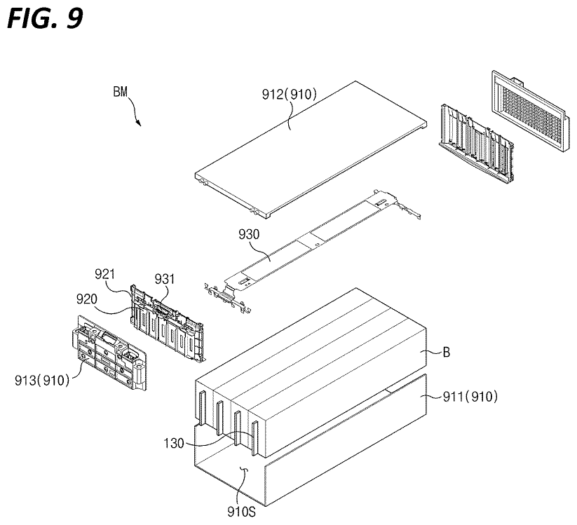

The electrode lead 130 may serve as a passage through which electricity is discharged to the outside. When the electrode lead 130 is relatively thick, the resistance decreases. Thus, the thickness H2 of the electrode lead 130 may be a predetermined value or more. However, when the electrode lead 130 is overly thick, a problem may occur in which the shape change is not easily performed. When the secondary batteries B are provided in the form of the battery module BM, the electrode lead 130 may be in contact with a busbar 920 (see, e.g., FIG. 9). While coming in contact with the busbar 920, the electrode lead 130 may need to be bent. Therefore, the thickness H2 of the electrode lead 130 may need to be an appropriate value.

The reason the electrode lead 130 is used as one of criteria for the thickness of the secondary battery B or the electrode stack 100 may be because the thickness of the electrode lead 130 may be easily measured since the electrode lead 130 may be made of material having relatively hard rigidity. Also, it may also be because the thickness is easy to measure since the electrode lead 130 protrudes to the outside of the secondary battery.

As described above, the electrode lead 130 may include the positive electrode lead 130a and the negative electrode lead 130b. Materials of the positive electrode lead 130a and the negative electrode lead 130b may be different from each other. Therefore, the appropriate thickness H2 may vary depending on the materials. The thickness of the positive electrode lead 130a may be about 0.4 mm, and the thickness of the negative electrode lead 130b may be about 0.2 mm. Alternatively, the thickness of the positive electrode lead 130a may be about 0.6 mm, and the thickness of the negative electrode lead 130b may be about 0.3 mm.

The thickness H1 of the electrode stack 100 may be about 15 times or more the thickness H2 of the electrode lead 130, so as to prevent or suppress heat transfer to an adjacent secondary battery B. Here, as an example, the electrode lead 130 may be the positive electrode lead 130a. When the thickness H1 of the electrode stack 100 is about 9 mm and the thickness H2 of the positive electrode lead 130a is about 0.6 mm, the thickness H1 of the electrode stack 100 may be about 15 times the thickness H2 of the positive electrode lead 130a. The thickness H1 of the electrode stack 100 may be greater than about 15 times the thickness of the positive electrode lead 130a such that the thickness H1 may be larger than the thickness of a conventional electrode stack 100.

According to one embodiment, the thickness H1 of the electrode stack 100 may be about 22 times or more the thickness H2 of the positive electrode lead 130a. When the thickness H1 of the electrode stack 100 is about 9 mm, and the thickness H2 of the positive electrode lead 130a is about 0.4 mm, the thickness H1 of the electrode stack 100 may be about 22 times the thickness of the positive electrode lead 130a. The thickness H1 of the electrode stack 100 may be greater than about 22 times the thickness of the positive electrode lead 130a such that the thickness H1 may be larger than the thickness of the conventional electrode stack 100.

According to one embodiment of the present disclosure, the thickness H1 of the electrode stack 100 may be about 70 times or more the thickness H2 of the positive electrode lead 130a. When the thickness H1 of the electrode stack 100 is about 28 mm, and the thickness H2 of the positive electrode lead 130a has a relatively small value of about 0.4 mm, the thickness H1 of the electrode stack 100 may be about 70 times the thickness H2 of the positive electrode lead 130a. As described below, the effect obtained when the thickness H1 of the electrode stack 100 is about 28 mm may be confirmed, and thus the thickness H1 of the electrode stack 100 may be relatively large.

According to one embodiment, when the thickness of the positive electrode lead 130a is about 0.6 mm, and the thickness H1 of the electrode stack 100 is about 28 mm, the thickness H1 of the electrode stack 100 may be about 46.7 times the thickness H2 of the positive electrode lead 130a. The thickness H1 of the electrode stack 100 may be about 46.7 times or more the thickness H2 of the positive electrode lead 130a.

With a focus on the negative electrode lead 130b, the thickness H1 of the electrode stack 100 may be about 30 times or more the thickness H2 of the negative electrode lead 130b. When the thickness H1 of the electrode stack 100 is about 9 mm, and the thickness H2 of the negative electrode lead 130b is about 0.3 mm, the thickness H1 of the electrode stack 100 may be about 30 times the thickness H2 of the negative electrode lead 130b. The thickness H1 of the electrode stack 100 may be greater than about 30 times the thickness of the negative electrode lead 130b such that the thickness H1 may be larger than the thickness of the conventional electrode stack 100.

According to one embodiment of the present disclosure, the thickness H1 of the electrode stack 100 may be about 45 times or more the thickness H2 of the negative electrode lead 130b. When the thickness H1 of the electrode stack 100 is about 9 mm, and the thickness H2 of the negative electrode lead 130b is about 0.2 mm, the thickness H1 of the electrode stack 100 may be about 45 times the thickness H2 of the negative electrode lead 130b. The thickness H1 of the electrode stack 100 may be greater than about 45 times the thickness of the negative electrode lead 130b such that the thickness H1 may be larger than the thickness of the conventional electrode stack 100.

According to one embodiment of the present disclosure, the thickness H1 of the electrode stack 100 may be about 140 times or more the thickness H2 of the negative electrode lead 130b. When the thickness H1 of the electrode stack 100 is about 28 mm, and the thickness H2 of the negative electrode lead 130b has a relatively small value of about 0.2 mm, the thickness H1 of the electrode stack 100 may be about 140 times the thickness H2 of the negative electrode lead 130b. As described below, the effect obtained when the thickness H1 of the electrode stack 100 is about 28 mm may be confirmed, and thus, the thickness H1 of the electrode stack 100 may be larger than about 28 mm.

According to one embodiment, when the negative electrode lead 130b is about 0.3 mm, and the thickness H1 of the electrode stack 100 is about 28 mm, the thickness H1 of the electrode stack 100 may be about 93.3 times the thickness H2 of the negative electrode lead 130b. The thickness H1 of the electrode stack 100 may be about 93.3 times or more the thickness H2 of the negative electrode lead 130b.

The above-described ratio of the thickness H1 of the electrode stack 100 to the thickness H2 of the electrode lead 130 was calculated through an example where the thickness H2 of the electrode lead 130 may have. However, the thickness H2 of the electrode lead 130 that is the basis for the calculation is not limited to the thickness H2 presented above. It may be understood that the above description has been made on the magnification of the thickness H1 of the electrode stack 100 with respect to the thickness H2 of the electrode lead 130.

Furthermore, the thickness H1 of the electrode stack 100 may be a factor for explaining the thickness D1 of the secondary battery B. This is because the thickness increase of the electrode stack 100 contributes to the thickness increase of the secondary battery B. In addition, in calculating the thickness D1 of the secondary battery B, the thickness of the battery casing 200 may be taken into consideration. As described above, the secondary battery B may further include the battery casing 200 configured to accommodate the electrode stack 100. Therefore, it may be understood that the above description on the thickness may be replaced by the description on the thickness D1 of the secondary battery B including the battery casing 200. This is because when the battery casing 200 is formed of a pouch film, the thickness of the pouch film may be similar to the thickness H2 of the electrode lead 130, and the thickness H2 of the electrode lead 130 may be very thin compared to the thickness H1 of the electrode assembly EA, and thus even if the thickness of the battery casing 200 is added to the thickness H1 of the electrode assembly EA, a significant difference may not occur in the calculation.

As described above, the battery casing 200 may include the receiving portion 210 having a shape corresponding to the electrode stack 100. As illustrated in FIG. 1, when two facing receiving portions are provided in symmetry in a vertical direction, and information about the thickness D1 of the secondary battery B is replaced with information about the receiving portions 210, according to one embodiment, the depth of the receiving portion 210 may be about 7.5 times or more the thickness H2 of the electrode lead 130. In this case, the electrode lead 130 may be located at the center in the thickness direction with respect to the secondary battery B. The fact that the depth of the receiving portion 210 is about 7.5 times or more may be calculated in consideration of the fact that the electrode stack 100 is at least about 15 times or more the electrode lead 130, the thickness H1 of the electrode stack 100 may be considered as the thickness D1 of the secondary battery B including the battery casing 200, the receiving portions 210 may be provided as a vertically symmetrical pair, and the influence of the thicknesses of the side portions 220 on the depth of the secondary battery B is insignificant. Therefore, in consideration of this point, the lower limit of the depth of the receiving portion 210 may be determined by considering a case where the electrode lead 130 is the positive electrode lead 130a and a case where the electrode lead 130 is the negative electrode lead 130b. When the electrode lead 130 is the positive electrode lead 130a, the depth of the receiving portion 210 may be about 7.5 times, about 11 times, or about 35 times or more the thickness H2 of the positive electrode lead 130a. Further, the depth of the receiving portion may be about 15 times, about 22.5 times, or about 70 times or more the thickness H2 of the negative electrode lead 130b.

As described above, the receiving portions 210 may be provided as a pair and located on opposite sides of the electrode stack 100. The sum of depths of the pair of receiving portions 210 may be about 28 mm or more. This merely indicates a numerical value according to one embodiment of the present disclosure, and as described above, the sum of depths of the pair of receiving portions 210 may be about 14 mm, or about 20 mm or more in order to achieve the effect of the present disclosure.

In the above description, the thickness D1 of the secondary battery B has been described by using the thickness H1 of the electrode stack 100. According to one embodiment of the present disclosure, the thickness D1 of the secondary battery B may be described on the basis of the full length D3 and/or the full width D2 of the secondary battery B. The directions of the full length D3 and the full width D2 may be referred to in FIG. 2.

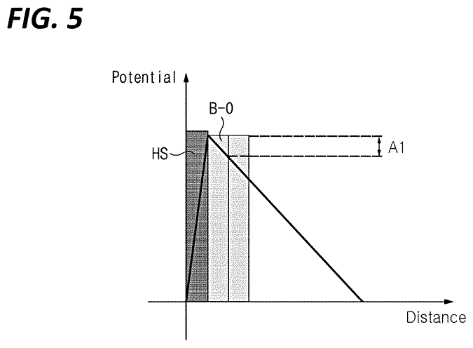

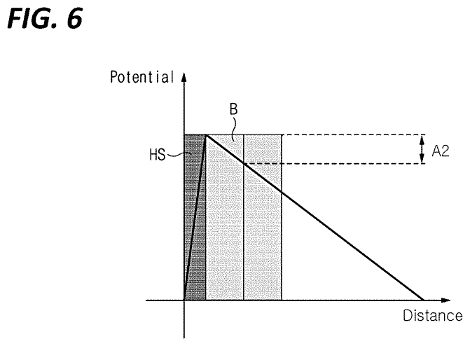

FIG. 5 is a graph illustrating a change in thermal energy according to a distance when a heat source HS is placed on one side of a secondary battery B-0 according to Comparative Example. FIG. 6 is a graph illustrating a change in thermal energy according to a distance when a heat source HS is placed on one side of the secondary battery B according to the first embodiment of the present disclosure. As illustrated in FIG. 5 and FIG. 6, the thickness of the secondary battery B according to the first embodiment is larger than the thickness of the secondary battery B-0 according to Comparative Example.

In FIG. 5, a plurality of secondary batteries B-0 is disposed such that they are in contact with each other in one direction. Here, the heat source HS may be disposed to be in contact with one side of the plurality of secondary batteries B-0. When a certain amount of heat is applied from the heat source HS, the secondary battery B-0 may have maximum thermal potential energy on the side in contact with the heat source HS. In a direction in which the secondary batteries B-0 get far away from the heat source HS, the thermal potential energy may exhibit a decreasing trend.

In FIG. 6, a plurality of secondary batteries B according to the first embodiment is disposed on one side of the heat source HS such that they are in contact with each other in one direction. In FIG. 6, when a certain amount of heat is applied from the heat source HS as in FIG. 5, in a direction in which the secondary batteries B get far away from the side in contact with the heat source HS, the thermal potential energy may show a decreasing trend. However, unlike in FIG. 5, since the thickness of the secondary battery B according to the first embodiment is larger than the thickness of the secondary battery B-0 according to Comparative Example, the amount A2 of thermal energy, which is reduced when the energy passes through the secondary battery B in contact with the heat source HS, is greater than the amount A1 of thermal energy, which is reduced when the energy passes through the secondary battery B-0 in contact with the heat source HS. Therefore, the secondary battery B having a large thickness transfers lower thermal energy to the adjacent secondary battery B than the secondary battery B-0 having a small thickness.

FIG. 7 is a graph summarizing the results of an experiment conducted to determine the effect of the thickness of the secondary battery B according to the first embodiment of the present disclosure, on heat transfer.

In the experiment from which the results of FIG. 7 were obtained, the secondary battery B having a thickness D1 of 14 mm and the secondary battery B having a thickness D1 of 28 mm were placed in contact with the same heat source HS on one side, and the temperatures were measured on the opposite side. In the two graphs, it can be seen that the portion where the temperature rapidly rises is a portion where a thermal runaway occurs.

Even if the thicknesses were different, the temperatures increased by the thermal runaway were approximately the same at 750° C.

Meanwhile, it took a longer time until a thermal runaway occurs in the secondary battery B having a relatively large thickness of 28 mm compared to the secondary battery B having a relatively small thickness of 14 mm. From this, it can be found that more heat is required to cause a thermal runaway in the relatively thick secondary battery B compared to the relatively thin secondary battery B. This may mean that when a plurality of secondary batteries B is provided, the thicker the secondary battery B that is a trigger for occurrence of a thermal runaway, the later the trigger bursts. In the meantime, it can be found that when even thinner secondary battery B is provided, a thermal runaway occurs with the supply of only a relatively small amount of heat, and thus, the stability against the thermal runaway is degraded.

Furthermore, it can be found that when a plurality of secondary batteries B is provided, even if one secondary battery B undergoes thermal runaway, the thermal runaway is difficult to spread because the relatively thick secondary battery B needs more heat in order to cause the adjacent secondary battery B to undergo the thermal runaway. When an adjacent secondary battery B undergoes thermal runaway, in consideration of the fact that the temperature rises to about 750° C. as illustrated in FIG. 7, due to such heat, the relatively thin secondary battery B relatively easily undergoes thermal runaway, thereby causing a subsequent thermal runaway. In the meantime, even if the temperature of the adjacent secondary battery B rises to about 750° C., a thermal runaway may not occur in the relatively thick secondary battery B because it is difficult to reach the heat amount sufficient for causing a thermal runaway in the relatively thick secondary battery B.

Further, as illustrated in FIG. 7, before the thermal runaway, the relatively thick secondary battery B may have a lower temperature than the relatively thin secondary battery B. Therefore, even if a thermal runaway does not occur, a temperature raised by the heat reaction may be relatively low in the thick secondary battery B, and thus the heat transferred to the adjacent secondary battery B may also be relatively small. Thus, when the relatively thick secondary battery B is used, the thermal runaway of the adjacent secondary battery B may be further relatively prevented or suppressed.

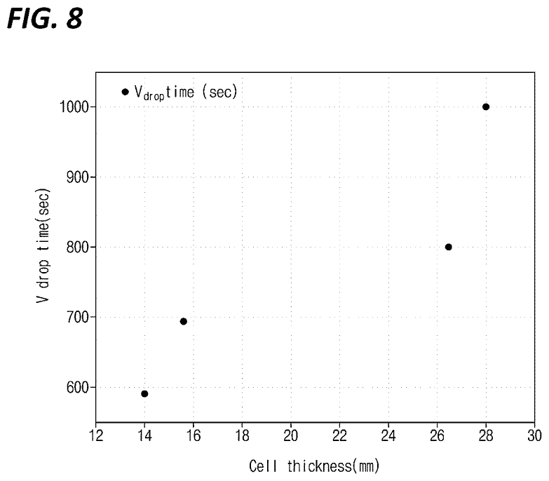

FIG. 8 is a graph illustrating the time for a voltage drop measured by varying the thickness of the secondary battery B in relation to the experiment illustrated in FIG. 6 or FIG. 7.

Referring to FIG. 8, descriptions will be made on the relationship between an increase in the thickness of the secondary battery B and the speed of heat propagation.

The x axis of the graph illustrated in FIG. 8 corresponds to the thickness of the secondary battery B. The y axis of the graph illustrated in FIG. 8 corresponds to the time taken until the voltage drops. For example, the time of the voltage drop corresponding to the y axis represents the time during which a voltage starts to drop at 3.3V and then reaches 0.03V. At 3.3V, the secondary battery B is determined to be fully charged. The secondary battery B may start to break down due to the heat source, and a voltage drop may occur. The time taken to reach a voltage at which the secondary battery B can be determined to be completely damaged (e.g., 0.03V) is measured by an experiment and is illustrated in FIG. 8. Here, it can be understood that the reason the voltage drop to 0.03V rather than 0V is determined is because a voltage drop to 0V is actually unlikely to occur and thus a voltage drop to 0.03V, which is close to this, is determined.

As illustrated in FIG. 8, it can be found that as the thickness of the secondary battery B increases, the time for the voltage drop increases accordingly. For example, it can be found that the time during which the secondary battery B is damaged by the heat source tends to increase as the secondary battery B becomes thicker. More accurate times are as listed in the following table 1.

TABLE 1

| Secondary battery thickness (mm) | Voltage drop time (sec) |
|---|---|
| 28 | 995 |
| 26.5 | 800 |
| 15.6 | 693 |
| 14 | 590 |

For the above table 1, an analysis may be performed as in the following table 2. The magnification expressed below is rounded to the second decimal place.

TABLE 2

| Secondary | Difference | Relative | Voltage | Difference | Relative |
|---|---|---|---|---|---|
| battery | from | ratio | drop | from | ratio |
| thickness | minimum | between | time | minimum | between |
| (mm) | (mm) | differences | (sec) | (sec) | differences |
| 28 | 14 | 8.75 | 995 | 405 | 3.93 |
| 26.5 | 12.5 | 7.81 | 800 | 210 | 2.04 |
| 15.6 | 1.6 | 1 | 693 | 103 | 1 |
| 14 | 0 | N/A | 590 | 0 | N/A |

In analyzing the trend of the voltage drop time according to the thickness of the secondary battery B, since it is difficult to assume that the secondary battery is 0 mm, it is difficult to simply determine that the voltage drop time increased by less than twice, for example, 1.69 times from 590 sec to 995 sec, despite the two-fold increase from 14 mm to 28 mm. In order to eliminate the effect of the initial value, an analysis based on a difference was conducted.

In the above table 2, in the column on the right side of the thickness of the secondary battery B, the differences from the minimum thickness of the secondary battery B, and relative ratios between the differences are listed. In the above table 2, in the column on the right side of the voltage drop time, the differences from the minimum of the voltage drop time, and relative ratios between the differences are listed. For example, the relative ratio between differences from the minimum thickness of the secondary battery B means the ratio of the difference value from the minimum, in the corresponding row, with respect to the smallest difference value (1.6) from the minimum. The relative ratio between differences from the minimum of the voltage drop time may also be obtained in the same manner as the relative ratio between differences from the minimum thickness of the secondary battery B.

For example, from the row for 28 mm of the thickness of the secondary battery B, it is seen that the ratio of the difference in the voltage drop time is 3.93 times whereas the ratio of the difference in the thickness of the secondary battery B is 8.75 times. Through this, it can be found that the increase rate of the voltage drop time is smaller than the increase rate of the thickness of the secondary battery B. For example, it can be found that the rate at which the time for the secondary battery function degradation caused by the heat increases, is less than the rate at which the thickness increases.

Further, the number of electrodes according to the thickness of the secondary battery B used in the above experiment was measured as follows. In the following table 3, electrodes are divided into positive electrodes and negative electrodes, and the number of each is listed.

TABLE 3

| Secondary battery thickness | Positive electrode | Negative electrode |
|---|---|---|
| (mm) | (number) | (number) |
| 28 | 66 | 68 |
| 26.5 | 63 | 64 |
| 15.6 | 37 | 38 |
| 14 | 33 | 34 |

Referring to the above table 3, it can be found that as the thickness of the secondary battery B increases, the number of positive and negative electrodes increases. The fact that the secondary battery B becomes thicker does not simply mean that the thickness becomes thicker, but may mean that the number of electrodes 110 increases, allowing the secondary battery B to produce more electricity overall. In other words, the increase in the thickness of the secondary battery B is advantageous in that it not only slows down the heat propagation but also allows more electricity to be produced. In the above, in consideration of the fact that the thickness of the secondary battery B increases to 28 mm, a total of 134 or less electrodes may be provided in the electrode stack 100 included in the secondary battery B. Furthermore, when the thickness of the secondary battery B is 14 mm or more, heat propagation may be slower than that in a conventional secondary battery, and thus, a total of 67 or more electrodes may be provided in the electrode stack 100.

Further, as illustrated in the above table, the experiment was conducted by setting the maximum thickness of the secondary battery B to 28 mm. This may be because when the receiving portion 210 of the battery casing 200 is formed through stretching by a press, the maximum degree of stretching is 14 mm which is the limit of the depth that can be formed through stretching.

FIG. 9 is an exploded view illustrating the battery module BM including the secondary battery B illustrated in FIG. 2.

A plurality of secondary batteries B may be provided to form the battery module BM. That is, the battery module BM may include the secondary batteries B.

The battery module BM may include a module casing 910 configured to house at least one secondary battery B. The provided secondary batteries B may be stacked in one direction. The module casing 910 may have a shape that is provided to correspond to the shapes of the secondary batteries B.

The module casing 910 may include a module casing body 911 where a battery accommodation space 910S capable of accommodating the plurality of secondary batteries B is formed. The module casing body 911 may have a cross-section having a “U” shape, and in the module casing body 911, an opening communicating with the battery accommodation space 910S may be formed. The module casing 910 may include a module casing cover 912 that covers at least one of openings formed in the module casing body 911. For example, the module casing body 911 may be configured to cover the lower side, and the left and right sides of the battery accommodation space 910S, and the module casing cover 912 may be configured to have a plate shape that covers the top side of the battery accommodation space 910S. The module casing 910 may include end plates 913 that cover the front and rear sides of the battery accommodation space 910S.

A busbar frame 921 may be provided to be accommodated in the battery accommodation space 910S and adjacent to the end plate 913. The busbar 920 may be mounted on the busbar frame 921. In the above-described secondary battery B, electricity generated in the electrodes 110 may move toward the electrode lead 130 through the electrode tabs 113. The end of each electrode lead 130 may be in contact with the busbar 920 so that electricity discharged from the electrode lead 130 of each of the secondary batteries B may be controlled. The busbars 920 may be provided while corresponding to the electrode leads 130, respectively. The busbar 920 may be, for example, a plate-shaped metal plate. The thickness of the electrode lead 130 may be thinner than the busbar 920. When the electrode lead 130 comes in contact with the busbar 920 and the electricity moving through the electrode lead 130 flows through the busbar 920, the electricity may be supplied to a component that requires electricity and is in contact with the busbar 920. Since the busbar 920 may have a larger thickness than the electrode lead 130, an electrical connection may be implemented more easily than a direct electrical connection to the electrode lead 130. These busbars 920 may be mounted and fixed to the busbar frame 921. The busbars 920 may be coupled to the busbar frame 921 by force-fitting. However, the present disclosure is not limited thereto, and it is thought that the spirt of the present disclosure is also applicable to the coupling of the busbars 920 with the busbar frame 921 by a fastening member or an adhesive. A part of the busbars 920 may be exposed to the outside of the end plate 913 to be described below and thus may have a configuration where a component requiring electricity is allowed to easily connect to the busbars 920.

The battery module BM may include the plurality of secondary batteries B, and the secondary batteries B may have different voltages during operation. The secondary batteries B may have the same voltage so that their respective charging states may be maintained at the same level. Also, even when the secondary batteries B are charged, charging can be performed in the same manner. Therefore, it may be required to monitor the voltages of the secondary batteries B.

To this end, the battery module BM may include a board 930. The board 930 is configured to be in contact with the busbars 920 through which electricity of the plurality of secondary batteries B flows. Then, a connector 930 may be mounted on the board 930. The connector 930 may be connected to a voltage management system (Battery Management System, BMS) configured to monitor the voltages of the secondary batteries B. The BMS is electrically connected to the connector 930. Then, the BMS may receive information about the voltages of the secondary batteries B when the information about the voltages is received by the board 930 in contact with the busbars 920 and is transmitted to the BMS through the connector 930. The BMS may control each of the secondary batteries B on the basis of the received voltage information about each of the secondary batteries B, such that each of the secondary batteries B may have a voltage within a preset range.

Hereinafter, embodiments different from the first embodiment will be described. Descriptions of other embodiments will be made focusing on differences while contents common to these embodiments and the first embodiment will be omitted as much as possible. That is, it is obvious that some contents not described for other embodiments may be supplemented by contents of the first embodiment as necessary.

### Second Embodiment

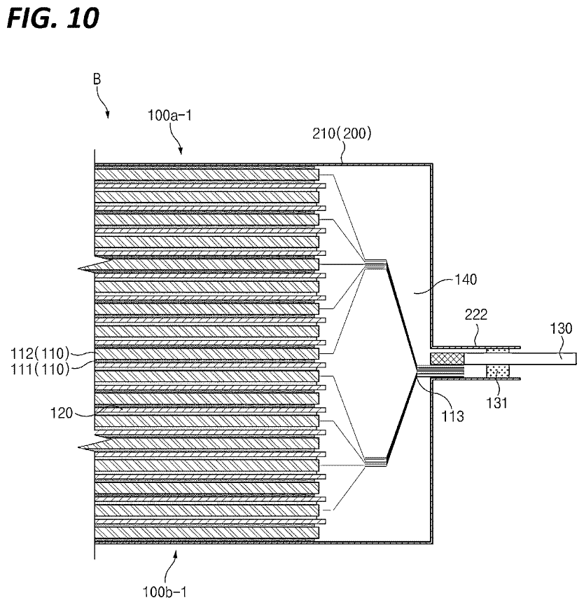

FIG. 10 is a cross-sectional view illustrating a secondary battery B according to a second embodiment of the present disclosure.

The second embodiment is different from the first embodiment in that a plurality of electrode stacks 100-1 is provided in the second embodiment.

The electrode stacks 100-1 may be arranged in the thickness direction. As illustrated in FIG. 10, according to the embodiment, the plurality of electrode stacks 100-1 may include a first electrode stack 100a-1 and a second electrode stack 100b-1. Each electrode stack 100-1 forms a bundle to which individual electrode tabs 113 are connected, and individual bundle-shaped electrode tabs 113 may be coupled to the electrode lead 130 through a separate member.

### Third Embodiment

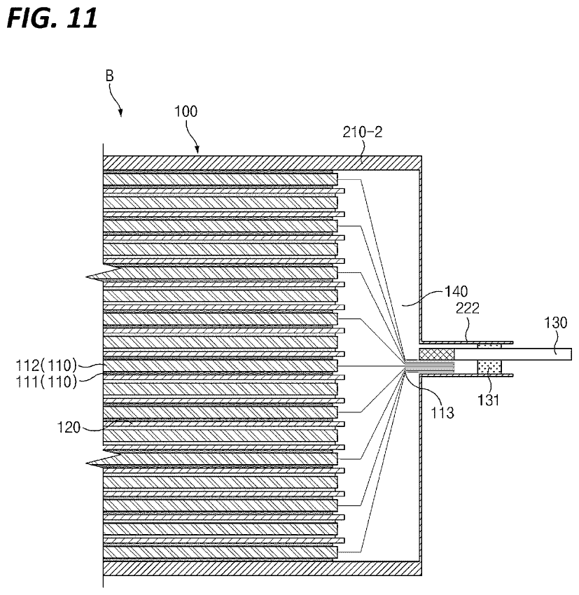

FIG. 11 is a cross-sectional view illustrating a secondary battery B according to a third embodiment of the present disclosure.

The third embodiment is different from the first embodiment in that the thickness of a receiving portion 210-2 is different from that of the first embodiment.

In order to prevent or suppress the propagation of a thermal runaway to the adjacent secondary battery B, the thickness D1 of the secondary battery B of the third embodiment may be increased by not only increasing the thickness H1 of the electrode stack 100, but also using a method of increasing the thickness of the receiving portion 210-2. This is because the thickness D1 of the secondary battery B may be formed by the sum of the thickness H1 of the electrode stack 100 and the thickness of the receiving portion 210-2.

According to the embodiment, the thickness of a bottom surface forming portion of the receiving portion 210-2 may be increased. For example, the thickness of the bottom surface forming portion of the receiving portion 210-2 may be larger than the thickness of a periphery forming portion of the receiving portion 210-2.

### Fourth Embodiment

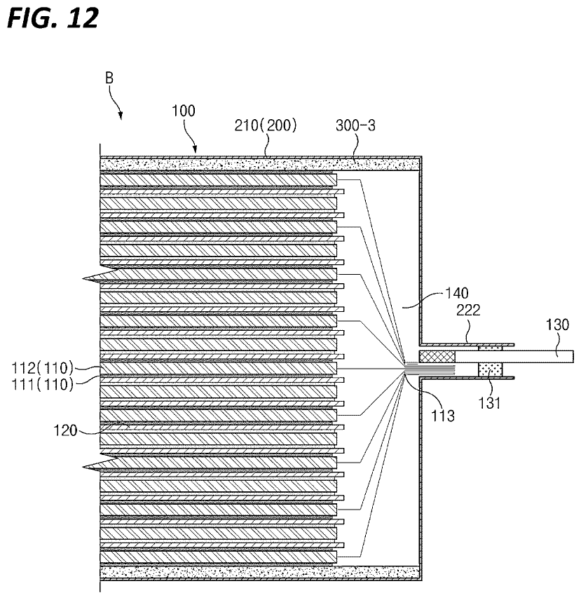

FIG. 12 is a cross-sectional view illustrating a secondary battery B according to a fourth embodiment of the present disclosure.

The fourth embodiment is different from the first embodiment in that the configuration of an insulation member 300-3 is further provided in the fourth embodiment.

The secondary battery B of the fourth embodiment may include the insulation member 300-3 located between the receiving portion 210 and the electrode stack 100. As the insulation member 300-3 is provided, the thickness D1 of the secondary battery B may be larger than before.

The insulation member 300-3 may have a lower thermal conductivity than the electrode assembly EA and/or the battery casing 200. Accordingly, the insulation member 300-3 may prevent or suppress the propagation of a thermal runaway to the adjacent secondary battery B.

### Fifth Embodiment

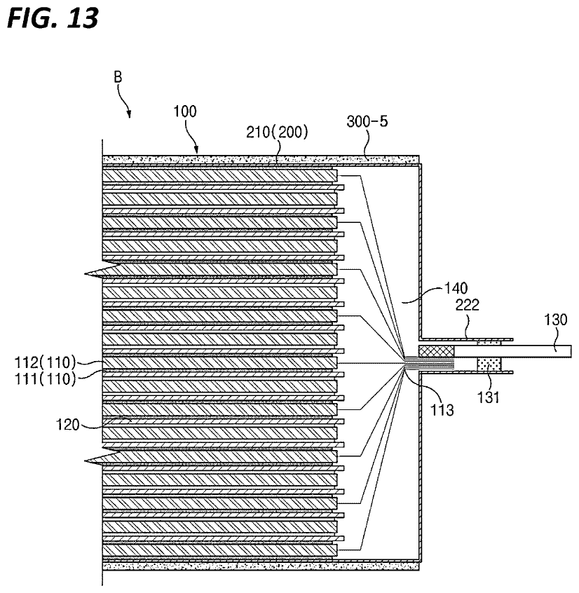

FIG. 13 is a cross-sectional view illustrating a secondary battery B according to a fifth embodiment of the present disclosure.

The fifth embodiment is different from the first embodiment in that the configuration of an insulation member 300-5 is further provided in the fifth embodiment. The fifth embodiment is different from the fourth embodiment in that the location of the insulation member 300-5 is different in the fifth embodiment.

The insulation member 300-5 may be located outside the receiving portion 210 in the fifth embodiment. The insulation member 300-5 may be in contact with the receiving portion 210 from the outside of the receiving portion 210. Accordingly, the insulation member 300-5 may increase the thickness D1 of the secondary battery B, and may prevent or suppress the propagation of a thermal runaway to the adjacent secondary battery B.

Unless explicitly stated, the above-described embodiments may be combined with other embodiments. Alternatively, it should be considered that the combinations between embodiments are possible as long as a combination between one embodiment and another embodiment is not clearly limited. Any combination of one embodiment and another embodiment is considered to be disclosed in this document.

Although the present disclosure has been described above by means of limited embodiments and drawings, the present disclosure is not limited thereto, and various implementations are possible by a person with ordinary skill in the technical field to which the present disclosure pertains, within the technical spirit of the present disclosure and the equivalent scope of patent claims to be described below. Therefore, the technical scope of various embodiments of the present disclosure should not be limited to the contents described in the detailed description of the specification, but should be determined by the patent claims.

What is claimed is:

1. An electrode assembly comprising:
an electrode stack in which an electrode and a separator are alternately interposed; and
an electrode lead extending from the electrode,
wherein a thickness of the electrode stack is 15 times or more a thickness of the electrode lead so as to prevent or suppress heat propagation to an adjacent secondary battery.

2. The electrode assembly according to claim 1, wherein the electrode lead is a positive electrode lead.

3. The electrode assembly according to claim 1, wherein the electrode lead is a positive electrode lead, and
the thickness of the electrode stack is about 22 times or more the thickness of the positive electrode lead.

4. The electrode assembly according to claim 1, wherein the electrode lead is a positive electrode lead, and
the thickness of the electrode stack is about 70 times or more the thickness of the positive electrode lead.

5. The electrode assembly according to claim 1, wherein the electrode lead is a negative electrode lead, and
the thickness of the electrode stack is about 30 times or more the thickness of the negative electrode lead.

6. The electrode assembly according to claim 1, wherein the electrode lead is a negative electrode lead, and
the thickness of the electrode stack is about 45 times or more the thickness of the negative electrode lead.

7. The electrode assembly according to claim 1, wherein the electrode lead is a negative electrode lead, and
the thickness of the electrode stack is about 140 times or more the thickness of the negative electrode lead.

8. The electrode assembly according to claim 1, wherein the thickness of the electrode stack is about 14 mm or more.

9. The electrode assembly according to claim 1, wherein the thickness of the electrode stack is about 20 mm or more.

10. The electrode assembly according to claim 1, wherein the thickness of the electrode stack is about 28 mm or more.

11. The electrode assembly according to claim 1, further comprising a battery casing configured to accommodate the electrode stack,
wherein the battery casing includes a receiving portion having a shape corresponding to the electrode stack, and
a depth of the receiving portion is about 7.5 times or more the thickness of the electrode lead.

12. The electrode assembly according to claim 11, wherein a pair of receiving portions is provided to be located on opposite sides of the electrode stack, respectively, and
a sum of depths of the pair of receiving portions is about 28 mm or more.

13. The electrode assembly according to claim 1, wherein a thickness is about 0.28 times or more a full length.

14. The electrode assembly according to claim 1, wherein a thickness of the electrode assembly is about 0.09 times or more a full width.

15. The electrode assembly according to claim 1, wherein a plurality of electrode stacks is provided, and
the electrode stacks are arranged in a thickness direction.

16. A secondary battery comprising:
an electrode stack in which a plurality of electrodes and a plurality of separators are provided, each of the plurality of separators being alternately stacked with the plurality of electrodes; and
a battery casing that accommodates the electrode stack,
wherein the electrode stack includes 134 or less electrodes to prevent or suppress heat propagation to an adjacent secondary battery.

17. The secondary battery according to claim 16, wherein the electrode stack includes 67 or more electrodes.

18. The secondary battery according to claim 16, wherein the electrode stack has a thickness of 28 mm or less.

19. The secondary battery according to claim 16, wherein a thickness of the electrode stack is 14 mm or more.

20. A secondary battery comprising:
an electrode stack; and
a battery casing that includes a receiving portion where a recessed space for accommodating the electrode stack is formed, and a side portion extending from the receiving portion,
wherein the receiving portion is formed through stretching by a press, and is configured to have a depth of about 14 mm or less, which is a maximum stretching degree.

21. The electrode assembly according to claim 1, further comprising an insulation member.

22. The electrode assembly according to claim 21, wherein the insulation member is located inside the receiving portion.

23. The electrode assembly according to claim 21, wherein the insulation member is located outside the receiving portion.
